(19) United States
(12) Patent Application Publication
(10) Pub. No.: US 2006/0207682 A1
(43) Pub. Date: Sep. 21, 2006

(54) Reactor bottom

(76) Inventor: Alexander Engel, (US)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/565,421

(22) PCT Filed: Jul. 23, 2004
(86) PCT No.: PCT/EP04/08260

§ 371 Date: Jan. 18, 2006

(30) Foreign Application Priority Data
Jul. 25, 2003 (DE) 10334371.7

(51) Int. Cl. B67C 11/04

(52) U.S. Cl. 141/331

(57) ABSTRACT

The invention relates to a bottom (2) for a reactor (1), comprising an upper side (5) in the form of a collector funnel (7), an opening (15) which is formed inside said collector funnel (7) and which is connected to a discharge channel (18) leading through the reactor bottom (2), and a closure part (16) for the opening (15), said closure part being movably arranged on the reactor bottom (2) and which can move between a closed position wherein it closes the opening (15) of the collector funnel (7) and a removal position wherein it is lowered into the reactor bottom (2), releasing a connection between the opening (15) and the discharge channel (18). The invention also relates to a method for separating a phase or capsules from a phase mixture or a hardening solution especially by means of sedimentation in a reactor provided with one such bottom.

The invention relates to a reactor bottom of a reactor which is especially intended for use in the encapsulation of cells, as well as to a method separating one phase from a phase mixture in a reactor with such a reactor bottom.

Methods for the encapsulation of cells, for example, microbial, plant or animal cells, or of biological and chemical substances are known. Merten et al (A new method for the encapsulation of mammalian cells; Cytotechnology 7; 121-130, 1991) describes a method of encapsulating mammalian cells whereby the capsules are produced from sodium cellulose sulfate (NaCS) and polydimethyldiallylammoniumchloride (PDMDAAC); the cells are thus mixed with NaCS and the resulting mixture is introduced into the PDMDAAC solution in droplets. DD 217 821 A1 describes the mixing of cells from the islets of Langerhans with NaCS and the dropping of the mixture into a precipitation bath that contains PDMDAAC. DD 217 821 A1 describes a method of producing an NaCS-PDMDAAC-microencapsulation system which contains hormone producing cells. Microcapsules of NaCS and PDADMAC are, among others, known as well from DD 160 393 A, DD 219 795 A1, DD 217 821 A1 and DD 274 051 A1. An improved apparatus for producing NaCS capsules is described in Cho (Method technique for designing an apparatus for producing microencapsulated biocatalysis with separate feed of catalysis solution and encapsulation base substance, Advances Report VDI, Series 17, Number 108; VDI Publishing 1994; ISSN 0178-9600). Other methods in which a cell suspension or a particle containing medium flows through a nozzle which thereby generates droplets with a coating or a layer thereon, for example, of polyacrylate, introduced into a hardening and recovered from the latter after a certain hardening time are known from, for example, DE 197 52 585 A1, U.S. Pat. No. 5,656,469 A or EP 0 778 083 A1. In these methods different encapsulation technology are used.

With a known apparatus for the encapsulation of cells (Encapsulator AP “medical” of the firm Inotech), for the harvesting of the capsules from the reactor or the reactor vessel, the reactor or reactor vessel must be removed from the apparatus. By shaking and tipping the reactor vessels, the capsules are caused to flow out of an outlet opening which is located about three centimeters above a reactor bottom in the wall of the reactor vessel into a collecting vessel or harvesting piston. This approach is not at all user friendly and gives rise to a nonutilizable residue of capsules in the reactor vessel.

It is the object of the invention to provide a reactor bottom of a reactor which has a simple construction but is greatly improved with respect to its use in the reactor, as well a method as mentioned at the outset with which the reactor bottom of the invention can be used to recover the desired phase or capsules in a simple manner from the reactor.

These objects are attained according to the invention by a reactor bottom with the features of claim 1 and by a method with the features of claim 14.

Advantageous configurations or embodiments of the invention are given in the respective dependent claims.

Since the reactor bottom of the reactor is formed as a collecting funnel, the phase of the phase mixture contained in the reactor which finds itself on the funnel base or at the funnel center or the capsule which are formed can be discharged or harvested by the harvesting opening form in the collecting funnel and led off through the outlet passage. A simple operation and servicing is enabled by the fact that a closure part is provided for the harvesting opening which is movable in the reactor bottom and can be displaced between a closed position in which the harvesting opening in the collecting funnel is closed and a discharge position in which it is lowered in the reactor bottom and establishes a connection between the harvesting opening and the outlet passage. As required, therefore, by displacing the closure part, the harvesting opening can be unblocked and the phase to be separated or the capsules can be drawn off through the outlet passage along the collecting funnel substantially without leaving a residue. A dismounting of the reactor or reactor vessel or separation thereof for the manual pouring or shaking out of the phase to be separated for the capsule is not required.

Advantageously, the upper surface or upper side of the closure part is shaped as a baffle or guide member to guide the content of the reactor or the phase mixture or the capsule out of the harvesting opening into the inlet passage. The baffle configuration supports the substantially or complete loss free discharge.

In a preferred embodiment, the upper surface or upper side of the closure part is formed with a collecting region with a deep lying level whereby the collecting region in the lowered discharged position of the closure part is juxtaposed with the outlet passage. The collecting region is especially a part of the deflecting or baffling device and it can for example be approximately a point shape or line shape region. A circular or annular and thereby approximately line shaped collecting region is for example formed by a concavely domed upper surface of the closure part along its edge at the periphery of the closure part. By lowering the closure part, capsules contained in the reactor collect on this peripheral side of the wall of the outlet recess and can flow readily into the discharge passage.

The harvesting opening is advantageously located in the region of the center of the collecting funnel in order to enable a complete discharge of the saved lying above the harvesting opening or the capsules. The harvesting opening can be located centrally with respect to the axis of the funnel or somewhat eccentrically to the axis or symmetrically or unsymmetrically with respect to the axis. The funnel itself may be configured symmetrically or unsymmetrically with respect to the axis. It is especially preferred when the edge of the harvesting opening runs through the central axis of the collecting funnel or contacts the central axis of the collecting funnel and the surface of the closure part is inclined correspondingly to the inclination of the funnel surface at the location of the harvest opening or has a corresponding funnel shape. Because of this shape of the closure part in the lowered position thereof in which the harvesting opening is unblocked, this shape remains to ensure that no particles or capsules will remain upon discharge. In its closed position, advantageously the surface of the closure part is flush with the surface of the collecting funnel. In the open position of the closure part, the collecting funnel can be emptied without leaving a residue. Generally with a central or eccentric arrangement of the harvesting opening or the closure part, the surface of the closure part can be inclined relative to the central axis or ball shaped so that upon this surface no residue of particles or capsules can remain when the particles or capsules flow or stream out of the reactor.

Preferably, extending from the harvesting opening in the reactor bottom and extending preferably parallel to the central axis of the collecting funnel is an outlet recess which receives the closure part slidably and in which the at least one outlet passage opens. The outlet recess can be formed by a bore with a round cross section or can have a nonround, for example an elliptical or rectangular cross section. Instead of a parallel and especially central arrangement of the outlet recess to the central axis of the collecting funnel, it may run at an acute angle to the central axis.

When, according to a preferred embodiment, in the wall of the outlet recess a ring-shaped or annular groove and/or a plurality of openings are formed, which can communicate with the outlet passage, the discharge or harvest of the capsules can occur more rapidly because of the increase outlet cross section.

Further, it is advantageous to provide at least one outlet passage covered by a sieve, opening into the collecting funnel. Through the outlet passage a second, especially liquid, phase can be discharged from the reactor or drawn off by suction therefrom through this outlet passage. Moreover, a sparging or washing liquid can be discharged if the reactor has previously been supplied with it, in order to wash or rinse out the capsules or generally any product formed in the reactor. Such a sparging process can be carried out one or a number of times.

The reactor bottom can be formed in one piece with the reactor or the reactor wall. Alternatively, it can be provided that the reactor or the reactor wall is separatively connected with the reactor bottom and fixed on the upper side of the reactor bottom so that the reactor wall will surround the collecting funnel. The reactor bottom is made for example from a plastic like for example polytetrafluoroethylene [PTFE]. The collecting funnel can also be affixed as a separate sheet or plastic part to the reactor bottom.

The closure part can be shiftable manually or by means of a drive device arranged on the reactor bottom.

Especially when the contents of the reactor are to be mixed by a mixing device, the funnel angle of the collecting funnel should preferably amount to substantially 130° to 170° and especially 153°. As a general matter, the funnel angle can be selected in dependency upon the capsules or phases to be separated and their flow characteristics and can have any suitable angle.

In the method according to the invention for separating a phase from a phase mixture in a reactor with a reactor bottom as described previously, the phase mixture is introduced into the reactor, the phases are separated therein and the desired phase in a closed position of the closure part deposits on the reactor bottom, whereupon a connection is opened between the harvesting opening and the outlet passage and the desired phase discharged through the harvesting opening and the outlet passage of the reactor. The advantage of this method is provided by the afore-described properties of the reactor bottom. Basically the phase mixture can contain two or even more than two phases.

According to a preferred mode of carrying out the method, the phase mixture is a mixture of a solid and a liquid phase and the phase separation is effected by sedimentation of the solid phase, whereby capsules especially form the solid phase. The phase separation by means of sedimentation is especially advantageous when the phase mixture is a hardening bath with capsules contained in the hardening bath as the phase to be separated and the capsules deposit upon the bottom of the collecting funnel from which they can be removed.

The capsules are for example NaCS capsules and contain advantageously biological cells, especially animal, human or plant cells.

According to a further advantageous method step it can be provided that, in the production of capsules, especially NaCS capsules, the hardening bath is discharged through the outlet passage and a rinsing or sparging liquid is introduced into the reactor and also discharged through the outlet passage, whereby this method step can be carried out once or a plurality of times.

In the separation of a phase from a phase mixture with for example two or more liquid phases, the desired phase which in the reactor for example forms a lower layer, can be discharged through the harvesting opening and outlet passage and the middle or the upper layer like phases can be discharged depending upon the particular phase or layer through the discharge passage or subsequently or in addition to the lower phase through the harvesting opening and the outlet passage.

Below an embodiment of the reactor bottom will be described in greater detail with reference to the drawing. The drawing shows:

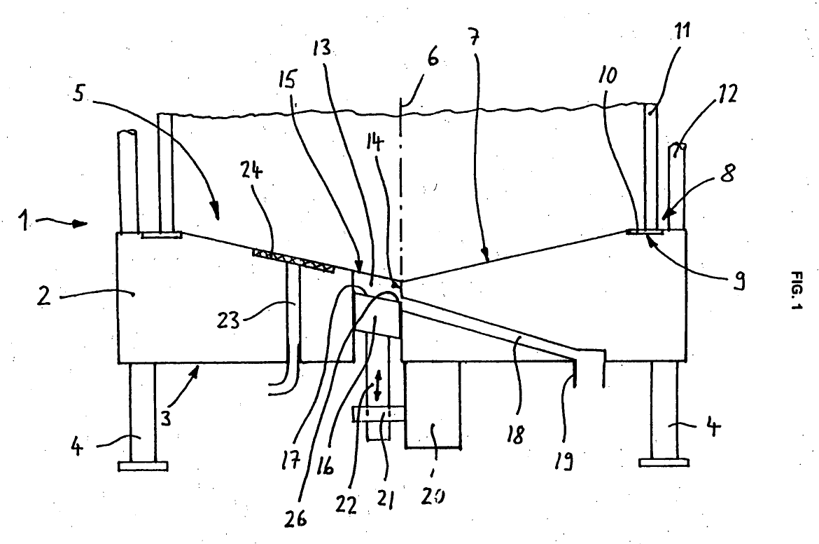

FIG. 1 in a vertical sectional elevation, a reactor bottom according to the invention with an outlet device;

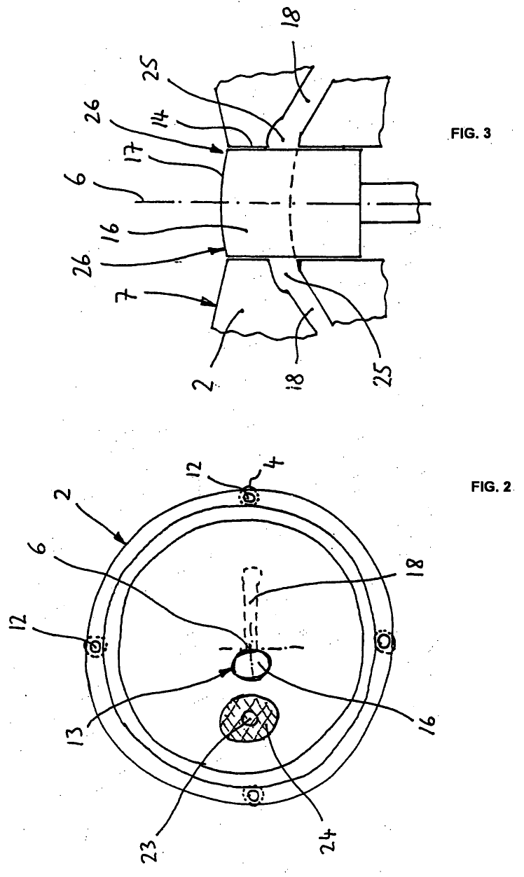

FIG. 2 in a plan view in smaller scale, the reactor bottom illustrated in FIG. 1; and,

FIG. 3 in a vertical sectional elevation to a greater scale, an embodiment of the reactor bottom with a modified outlet device.

A reactor 1 of a device for the encapsulation of cells, especially microbial, plant or animal cells or of biological and chemical substances, comprises a reactor bottom 2 which, for example, is formed from a circular or square plate of polytetrafluoroethylene [PTFE] and is supported on its underside 3 by a support device with for example four feet 4 which are fixed on the underside 3 of the reactor bottom 2. Alternatively, the support device can for example include a support frame upon which the reactor bottom 2 lies. The reactor bottom 2 is formed on its upper side 5 with a collecting funnel 7 having a central axis 6 and which is surrounded by an edge region 8 of the upper side and has a funnel angel or conical angle of for example 153°.

The edge region 8 includes preferably a flat shelf or ledge 9 to receive a sealing ring 10 upon which a reactor vessel, for example a glass cylinder 11, can be arranged in a liquid-tight relationship. Outside the glass cylinder 11 or the ledge 9 on the reactor bottom 2, preferably a holding device is provided which can be constituted by for example four rods 12 spaced apart around the periphery of the reactor bottom 2 and affixed to the reactor bottom. The rods 12 extend preferably to the upper part of the glass cylinder 11 and support a reactor head (not shown) by means of a releasable retaining device with the glass cylinder 11 and with which the head is fixed to the reactor bottom 2.

The reactor bottom has in addition an outlet or harvesting recess 13 which extends downwardly from the collecting funnel 7 in the reactor bottom 2 and for example is formed as a through going opening which connects the collecting funnel 7 with the underside 3 of the reactor bottom 2. The outlet recess which is for example formed as a cylindrical bore or through going opening is thus eccentric and especially arranged parallel to the central axis 6 so that its wall 14 for example contacts or coincides with the central axis 6 and extends downwardly from the deepest central point of the collecting funnel 7. In the inclined surface of the collecting funnel 7, therefore, a harvesting opening 15 is provided which communicates with the outlet recess.

A closure part 16 which for example is of piston shape and is vertically shiftable within the outlet recess 13 is slidably received therein and has a cross section corresponding to that of the outlet recess 13 so that it is sealingly received in the outlet recess 13. The seal of the closure part 16 results from the fact that there is a play-free fit of the closure part 16 which is made from a plastic like for example polytetrafluoroethylene [PTFE] in the outlet recess 13 and/or by a seal (not shown), for example, an O-Ring which can be arranged on the periphery of the closure part 16 and cooperates with the wall 14 of the outlet recess 13 in a sealing manner or, alternatively is provided in an annular groove in the wall 14. The closure part 16 can be secured against rotation for example by a nonround cross section of the closure part 16 or the outlet recess 13 or by a corresponding guide which prevents rotation of the circular cross section closure part 16 in the cylindrical outlet recess 13.

The upper side or upper surface of the closure part 16 is inclined and especially corresponds in shape and inclination to the continuation of the inclined surface of the collecting funnel 7 when the closure part is at its upper position and closes the harvesting opening 15 of the outlet recess 13 so that the closure part 16 will be flush with the surface of the collecting funnel 7 in its upper closed position.

The reactor bottom 2 contains, in addition, an outlet passage 18 which for example opens at one side in the wall 14 of the outlet recess 13 below the center and along the central axis 6 of the collecting funnel 7 and is formed in the underside 3 of the reactor bottom 2 to communicate for example with an outlet type or outlet fitting 19.

The closure part 16 is for example displacable or shiftable by means of a drive device in the outlet recess 13. The drive device can contain for example an electric drive motor 20 which is mounted on the underside 3 of the reactor bottom plate 2 and is coupled by a transmission and a screw device 21 with the spindle 22 connected to the closure part 16. In an alternative form, a manual lifting actuation or a manual shifting of the closure part 16 is provided.

The upper side or upper surface 17 of the closure part 16 forms, because of its shape, a guide or baffle device with a collecting region 26 at its lowest level so that the reactor content, for example a liquid or solid like capsules or the like are guided from the surface 17 in the discharge direction or in the direction of the outlet passage 18 so as to leave the collecting funnel residue free. With an inclined plane surface as shown, the collecting region 26 is formed around the periphery of the closure part 16 at the lowest point of the surface 17.

The reactor bottom 2 contains, in addition, a discharge passage 23 which is formed in the surface of the collecting funnel 7, preferably communicating with the underside 3 of the reactor bottom 2. The upper opening of the discharge passage 23, which opens at the surface of the collecting funnel 7 preferably close to the outlet recess 13, is preferably covered by a sieve 24.

In an alternative configuration (see FIG. 3) the outlet recess or through going bore is located centrally or coaxial with the central axis 6 of the collecting funnel 7. In the wall 14 of the outlet recess 13 a groove 25 is provided in the form of an annular passage in which at least one outlet passage 18 opens. The surface 17 of the closure part 16 is preferably domed or of convex configuration so that in the lowered discharge position of the closure part 16 (shown in broken lines in FIG. 3) the desired phase, especially formed capsules, will be discharged with reduced loss or loss free. The guide device is here formed by an annular dropped collecting region 26 along the edge of the upper surface 17 of the closure part 16 to guide the reactor contents, like for example the capsules, to the groove 25 or the annular channel.

The reactor is used for example for the encapsulation of cells. In this case, for example, a suspension of sodium cellulose sulphate and cells is dripped via a nozzle. The droplets fall into a hardening bath of PDADMAC. In this case, the closure part 16 is initially in its upper closed position flush with the surfaces of the collecting funnel 7 and the discharge passage 23 is also blocked. Following a hardening time, the hardening bath is discharged through the discharge passage 23 or is pumped off, whereby the sieve 24 holds back the encapsulated substances or capsules. Then a rinsing or sparging or washing liquid can be introduced into the reactor and after the washing of the capsule can be drawn off through the discharge passage 23. This washing process can be carried out once or repeated a number of times. To harvest the capsules, the closure part 16 is displaced downwardly until the opening to the outlet passage 18 in the wall 14 of the outlet recess 13 is unblocked and thus the capsule can flow through the harvesting opening 15 and the outlet passage 16 with minimum loss or in a loss free manner since there are no corners which must be negotiated by the flow or in the flow path and in which the capsules can remain. The upper surface 17 of the closure part 16 forms a guide device which enables and supports the loss free discharge of the capsules from the reactor 1.

Instead of capsules of cells or the like the reactor 1 with the described reactor bottom can be used generally for the separation of one phase of a phase mixture which is comprised of at least two phases, whereby the phase lying on the surface of the collecting funnel 7 is discharged through the harvesting opening 15 with minimum losses or even loss free.

### REFERENCE CHARACTER LIST

1 Reactor
2 Reactor bottom
3 Underside
4 Feet
5 Upper surface
6 Central axis
7 Collecting funnel
8 Edge region
9 Ledge
10 Ceiling ring
11 Glass cylinder
12 Rod
13 Outlet recess
14 Wall
15 Upper opening, harvesting opening
16 Closure part
17 Surface
18 Outlet passage
19 Connecting fitting
20 Drive motor
21 Screw device
22 Spindle
23 Discharge passage 24 Sieve
25 Groove 26 Collecting region

1. A reactor bottom (2) of a reactor (1)
with a collecting funnel (7) formed with an upper side (5),
with a receiving opening (15) formed in the collecting funnel (7) and which connects to an outlet passage (18) extending through the reactor bottom (2),
and with a closure part (16) for the harvesting opening (15) which is movably arranged in the reactor bottom (2) and displaceable between a closed position in which it closes the harvesting opening (17) of the collecting funnel (7), and a discharge position in which it is lowered in the reactor bottom (2) and establishes a connecting between the harvesting opening (15) and the outlet passage (18).

2. The reactor bottom according to claim 1 characterized in that the surface (17) of the closure part (16) is configured as a guide or baffle surface for guiding the reactor content from the harvesting opening (15) into the outlet passage (18).

3. The reactor bottom according to claim 1 characterized in that the surface (17) of the closure part (16) forms a collecting region (26) at a deep lying level whereby the collecting region (26) in the lowered discharge position of the closure part (16) is juxtaposed with the outlet passage (18).

4. The reactor bottom according to claim 3 characterized in that the collecting region (26) on the surface (17) of the closure part (16) is configured with a point shape or line shape.

5. The reactor bottom according to claim 1 characterized in that the harvesting opening (15) is located eccentrically to the central axis (6) of the collecting funnel (7) and especially the edge of the harvesting opening (15) coincides with the central axis (6) of the collecting funnel (7).

6. The reactor bottom according to claim 1 characterized in that the surface (17) of the closure part (16) is inclined with respect to the central axis (6) or is domed.

7. The reactor bottom according to claim 1 characterized in that the surface (17) of the closure part (16) is flush in its closed position to the surface of the collecting funnel (7).

8. The reactor bottom according to claim 1 characterized in that an outlet recess extends in the reactor bottom (2) from the harvesting opening (15) and is especially parallel to the central axis (6) of the collecting funnel (7) and receives the closure part (16) slidably and at least one outlet passage (18) opens into the outlet recess (13).

9. The reactor bottom according to claim 8 characterized in that an annular groove (25) is formed in the wall (14) of the outlet recess (13) and/or a plurality of openings are formed therein, which communicate with the outlet passage (18).

10. The reactor bottom according to claim 1 characterized in that at least one discharge passage (23) opens into the collecting funnel (7) and is closed with a sieve (24).

11. The reactor bottom according to claim 1 characterized in that the reactor bottom (2) is formed in one piece with the reactor (1) or the reactor wall (11) or that the reactor (1) or the reactor wall (11) is detachably connected to the reactor bottom (2) and is fixed on the upper side (5) of the reactor bottom (2) such that the reactor wall (11) surrounds the collecting funnel (7).

12. The reactor bottom according to claim 1 characterized in that the closure part (16) is displaceable manually or by means of a drive device (20, 21, 22) arranged on the reactor bottom (2).

13. The reactor bottom according to claim 1 characterized in that the funnel or conical angle of the collecting funnel (7) is substantially 130° to 170°, especially 153°.

14. A method of separating a phase from a phase mixture in a reactor with a reactor bottom according to claim 1 whereby the phase mixture is introduced into the reactor, the phases are separated and in the closed position of the closure part, deposits on the collecting funnel and then a connection is opened between the harvesting opening and the outlet passage whereby the desired phase is discharged through the harvesting opening and the outlet passage of the reactor.

15. The method according to claim 14 characterized in that the phase mixture is a mixture of solid and liquid phases and the phase separation is carried by sedimentation.

16. The method according to claim 14 characterized in that the phase mixture is a hardening bath and capsules are contained in the hardening bath as the phase to be separated.

17. The method according to claim 16 characterized in that especially before the withdrawal of the capsule in a further method step the hardening bath is discharged through the discharge passage and rinsing liquid is introduced into the reactor and is then discharged through the discharge passages, this method step being carried out once or a number of times.

18. The method according to claim 16 characterized in that the capsules are sodium cellulose capsules.

19. The method according to claim 16 characterized in that the capsules contain biological cells, especially animal, human or plant cells.
